(19) United States
(12) Patent Application Publication
(10) Pub. No.: US 2026/0017097 A1
(43) Pub. Date: Jan. 15, 2026

(54) COMPUTER-READABLE RECORDING MEDIUM, SERVICE PROVIDING METHOD, AND SERVICE PROVIDING APPARATUS

(71) Applicant: Fujitsu Limited, Kawasaki-shi (JP)

(72) Inventors: Tomoaki SHIOZAWA, Kobe (JP); Yukihiro TAKEUCHI, Akashi (JP); Yoshihiro KIMURA, Kobe (JP); Naoki KOJIMA, Kobe (JP)

(73) Assignee: Fujitsu Limited, Kawasaki-shi (JP)

(21) Appl. No.: 19/329,218

(22) Filed: Sep. 15, 2025

Related U.S. Application Data
(63) Continuation of application No. PCT/JP2023/046855, filed on Dec. 27, 2023.

(30) Foreign Application Priority Data
Mar. 22, 2023 (JP) 2023-045518

(51) Int. Cl. G06F 9/48; G06F 3/048; G06F 9/50

(52) U.S. Cl. CPC G06F 9/4881; G06F 3/048; G06F 9/5077

(57) ABSTRACT

A non-transitory computer-readable recording medium stores therein a program that causes a computer to execute a process including, in one resource that provides a job management service using a specific network, the resource having a plurality of tenants set therein, each of the tenants having a plurality of functions for performing job management set therein, each of the functions being allocated with a different subnetwork of the specific network, performing individual access restriction for each of the functions based on the subnetwork, and performing individual job management for each of the tenants using a shared function of the plurality of tenants in the job management provided in a commonly used portion of the plurality of tenants of the resource and the functions set for each of the tenants.

### CROSS-REFERENCE TO RELATED APPLICATION

This application is a continuation application of International Application No. PCT/JP2023/046855, filed on Dec. 27, 2023 which claims the benefit of priority of the prior Japanese Patent Application No. 2023-045518, filed on Mar. 22, 2023, the entire contents of which are incorporated herein by reference.

### FIELD

The embodiment discussed herein is related to a computer-readable recording medium, a service providing method, and a service providing apparatus.

### BACKGROUND

Recently, a growth rate of a cloud market is increasing, and a demand for cloud migration of existing IT (Internet Technology) assets is also increasing. For example, in the “cloud-by-default principle” announced by the government, utilization of cloud services is recommended for construction and maintenance of the government information system.

A demand for cloud migration is increasing, and the number of users who want to migrate a job management environment to the cloud is also increasing. Accordingly, in recent years, business operators providing a job management service on the cloud are attracting attention. Job management is a task of controlling and monitoring an execution of jobs such as program execution and batch processing to be appropriately executed. A job management service provider provides the job management service to a user using a computational resource on the cloud provided by a cloud infrastructure provider. Here, the user pays a service fee to the job management service provider. The job management service provider pays a cloud infrastructure fee to the cloud infrastructure provider.

For cloud migration of the job management environment, the user wants high operability to be ensured while usage costs are kept low. Therefore, considering user convenience, the job management service providers have been actively trying to construct a job management service that uses an existing product.

Here, in provision of the job management service on the cloud, two configurations of a single-tenant configuration and a multi-tenant configuration exist. The single-tenant configuration is a system in which a tenant using a service and a resource as a computational resource for providing a job management service are in a one-to-one relationship. The tenant is a unit in which elements for providing a job management role are grouped, in which the tenant and a user who uses a service may form a pair or one user may use a plurality of tenants. In the single-tenant configuration, since resources are not connected to each other across tenants, resources of one user do not access resources of another user. However, in the single-tenant configuration, the user needs to pay a fee for each resource.

Meanwhile, the multi-tenant configuration is a system in which one resource is used by a plurality of tenants. In the multi-tenant configuration, one resource is divided and used by a plurality of tenants, and ordinarily, one resource is not occupied by a single tenant. In the multi-tenant configuration, since an operation rate of resources tends to be higher than that in the single-tenant configuration, the cost for paying the cloud infrastructure fee can be reduced.

The single-tenant configuration may be more advantageous than the multi-tenant configuration from the viewpoint of ensuring security, but when the single-tenant configuration is introduced, the job management service provider needs to allocate each resource for each virtual network. Therefore, a cost burden of the cloud infrastructure fee paid by the job management service provider to the cloud infrastructure provider increases. Here, there is a possibility that the price of the cloud infrastructure fee is shifted to the user, thereby increasing the cost burden on the user. Therefore, for a user who uses a plurality of tenants, it is not realistic to use the job management service with the single-tenant configuration.

As a technology for controlling access, there has been proposed a technology in communication using InfiniBand in which subnet is applied for each tenant and a management partition is installed to prevent communication with other nodes. There has been proposed a technology in which a server transmits a control command via a network address conversion device to an external IP (Internet Protocol) address or the like of an IoT (Internet of Things) device, the address being received via the network address conversion device. There has been proposed a technology in which service is operated in the multi-tenant configuration using an integrated tenant for integrating a business server and a storage set by a management server. There has been proposed a technology in which an application program common to a plurality of tenants is constructed on a common application board and a service is managed by the multi-tenant configuration.
Patent Document 1: Japanese National Publication of International Patent Application No. 2019-505104
Patent Document 2: Japanese Laid-open Patent Publication No. 2020-14049
Patent Document 3: International Publication Pamphlet No. WO 2014/162497
Patent Document 4: Japanese Laid-open Patent Publication No. 2020-123299

However, when the multi-tenant configuration is introduced, in a simple multi-tenant configuration in which one resource is divided and used simply, it is difficult to ensure high reliability that is expected for the job management service. In the simple multi-tenant configuration, usage by a user having a plurality of tenant contracts is not considered, and manipulation of a plurality of tenants is complicated. Therefore, in the conventional provision of the job management service, it is difficult to ensure convenience of the service while ensuring security.

In any of the above-described access control technologies, ensuring reliability in the multi-tenant configuration or manipulation performance of a plurality of tenants are not considered in providing the service having the multi-tenant configuration on the cloud. Therefore, it is difficult to ensure convenience of the service while ensuring security.

### SUMMARY

According to an aspect of an embodiment, non-transitory computer-readable recording medium stores therein a program that causes a computer to execute a process including, in one resource that provides a job management service using a specific network, the resource having a plurality of tenants set therein, each of the tenants having a plurality of functions for performing job management set therein, each of the functions being allocated with a different subnetwork of the specific network, performing individual access restriction for each of the functions based on the subnetwork, and performing individual job management for each of the tenants using a shared function of the plurality of tenants in the job management provided in a commonly used portion of the plurality of tenants of the resource and the functions set for each of the tenants.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration of a job management service providing system according to an embodiment;

FIG. 2 is a block diagram of the job management service providing system;

FIG. 3 is a diagram illustrating setting information of a client ACL and a client FW;

FIG. 4 is a diagram illustrating setting information of a network load balancer ACL;

FIG. 5 is a diagram illustrating setting information of a job management manager ACL and a job management manager FW;

FIG. 6 is a sequence diagram of processing of manipulation of a job management manager by a user;

FIG. 7 is a sequence diagram of job management processing based on job information;

FIG. 8 is a diagram illustrating a list of job management functions;

FIG. 9 is a diagram illustrating a configuration in which a Web/REST server is made common;

FIG. 10 is an image diagram of an example of a job information display screen;

FIG. 11 is a sequence diagram of processing of manipulation of a job management manager using the Web/REST server;

FIG. 12 is an image diagram of connection of a job management service providing system according to a second embodiment;

FIG. 13 is a diagram of an example of a user information DB and a tenant information DB; and

FIG. 14 is a hardware configuration diagram of a computer.

### DESCRIPTION OF EMBODIMENT

Preferred embodiments of the present invention will be explained with reference to accompanying drawings. Note that the computer-readable recording medium, the service providing method, and the service providing apparatus disclosed in the present application are not limited by the following embodiments.

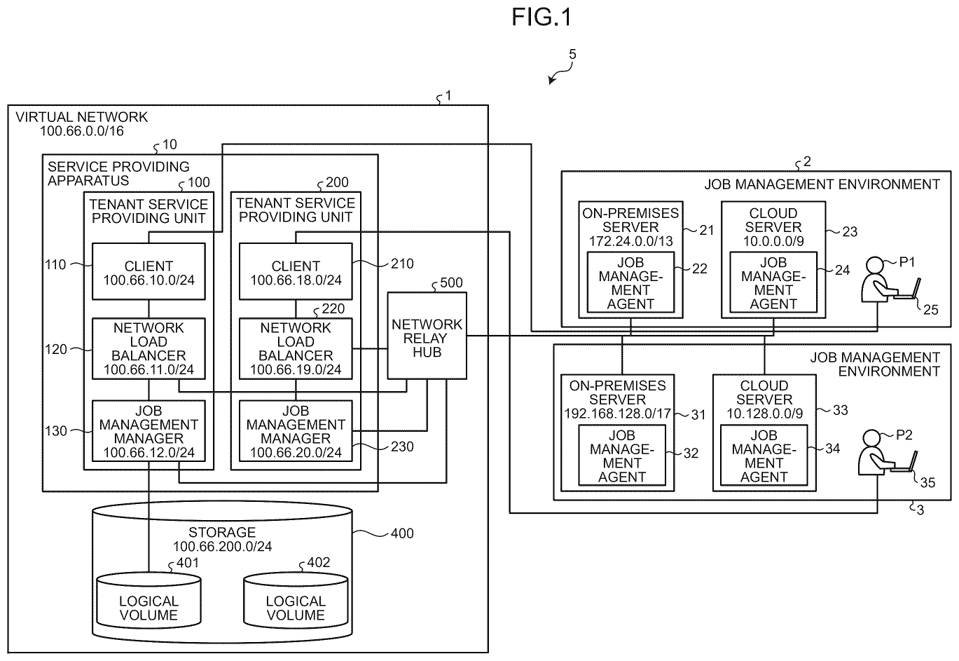

FIG. 1 is a diagram illustrating an example of a system configuration of a job management service providing system according to an embodiment. As illustrated in FIG. 1, a job management service providing system 5 includes a virtual network 1 and job management environments 2 and 3.

The job management environment 2 is a system on a user P1 side for managing a job executed in a task or the like of the user P1. The user P1 uses a user terminal apparatus 25. In the job management environment 2, each job is executed by an on-premises server 21 and a cloud server 23. A job management agent 22 operates on the on-premises server 21. A job management agent 24 operates on the cloud server 23. However, the server on which the job operates may be any of the on-premises server 21 or the cloud server 23.

The on-premises server 21 and the cloud server 23 can use an address conforming to RFC1918. For example, the on-premises server 21 uses an address of 172.24.0.0/13. The cloud server 23 uses an address of 10.0.0.0/9, for example.

The job management environment 3 is a system on a user P2 side for managing a job executed in a task or the like of the user P2 different from the user P1. The user P2 uses a user terminal apparatus 35. In the job management environment 3, each job is executed by an on-premises server 31 and a cloud server 33. A job management agent 32 operates on the on-premises server 31. A job management agent 34 operates on the cloud server 33. However, the server on which the job operates may be any of the on-premises server 31 or the cloud server 33.

The on-premises server 31 and the cloud server 33 can use an address conforming to RFC1918. For example, the on-premises server 31 uses an address of 192.168.128.0/17. The cloud server 33 uses an address of 10.128.0.0/9, for example.

Each apparatus of the job management environments 2 and 3 is connected to the virtual network 1. A collection of computational resources accommodated in the virtual network 1 corresponds to one resource for performing job management. The virtual network 1 in FIG. 1 corresponds to one resource. Various information processing apparatuses accommodated in the virtual network 1 provide a job management service for jobs operating on the on-premises server 21 or the cloud server 23 as well as the on-premises server 31 or the cloud server 33.

Specifically, in the virtual network 1, a system for job management for each of a plurality of tenants is provided. In the present embodiment, the virtual network 1 uses a shared address conforming to RFC6598. For example, the virtual network 1 uses an address of 100.66.0.0/16. In the virtual network 1, for example, a service providing apparatus 10, a network relay hub 500, and a storage 400 are provided. The virtual network 1 corresponds to an example of a “specific network”.

The storage 400 also uses a shared address conforming to RFC6598. For example, the storage 400 uses an address of 100.66.200.0/24. The storage 400 is commonly used by the users P1 and P2 by subnetwork division.

The storage 400 includes logical volumes 401 and 402. The logical volume 401 is associated with a job management manager 130 of a tenant service providing unit 100 in the service providing apparatus 10. The logical volume 402 is associated with a job management manager 230 of a tenant service providing unit 200 in the service providing apparatus 10. As a result, access to the storage 400 by the user P1 is limited to the logical volume 401, and access to the storage 400 by the user P2 is limited to the logical volume 402.

The service providing apparatus 10 includes the tenant service providing units 100, 200, and the like that perform job management. Here, the service providing apparatus 10 may be one server or may include a plurality of servers. In the tenant service providing units 100 and 200, from the viewpoint of use by the users P1 and P2, each of the tenant service providing units 100 and 200 corresponds to a tenant.

The tenant service providing unit 100 manages jobs operating on the on-premises server 21 and the cloud server 23 used by the user P1. The tenant service providing unit 200 manages jobs operating on the on-premises server 31 and the cloud server 33 used by the user P2.

The tenant service providing unit 100 includes a client 110, a network load balancer 120, and the job management manager 130. Different subnetworks in the virtual network 1 are allocated to each of the client 110, the network load balancer 120, and the job management manager 130.

In the present embodiment, a subnetwork having an address of 100.66.10.0/24 among shared addresses conforming to RFC6598 is allocated to the client 110. A subnetwork having an address of 100.66.11.0/24 among the shared addresses conforming to RFC6598 is allocated to the network load balancer 120. A subnetwork having an address of 100.66.12.0/24 among the shared addresses conforming to RFC6598 is allocated to the job management manager 130. The subnetwork allocated to the client 110 corresponds to an example of a “first subnetwork”. The subnetwork allocated to the job management manager 130 corresponds to a “second subnetwork”.

The network load balancer 120 and the job management manager 130 are connected to the on-premises server 21 and the cloud server 23 via the network relay hub 500. In the present embodiment, the client 110 is connected to the user terminal apparatus 25 using a network path different from the path connected to the network relay hub 500. The client 110 may be connected to the user terminal apparatus 25 via the network relay hub 500.

The client 110 performs access restriction using an access control list (ACL) and a fire wall (FW). The network load balancer 120 performs access restriction using ACL. The job management manager 130 performs access restriction using ACL and FW.

Similarly, the tenant service providing unit 200 includes a client 210, a network load balancer 220, and the job management manager 230. Different subnetworks in the virtual network 1 are allocated to each of the client 210, the network load balancer 220, and the job management manager 230.

In the present embodiment, a subnetwork having an address of 100.66.18.0/24 among the shared addresses conforming to RFC6598 is allocated to the client 210. A subnetwork having an address of 100.66.19.0/24 among the shared addresses conforming to RFC6598 is allocated to the network load balancer 220. A subnetwork having an address of 100.66.20.0/24 among the shared addresses conforming to RFC6598 is allocated to the job management manager 230. The subnetwork allocated to the client 210 corresponds to an example of a “first subnetwork”. The subnetwork allocated to the job management manager 230 corresponds to a “second subnetwork”.

The network load balancer 220 and the job management manager 230 are connected to the on-premises server 31 and the cloud server 33 via the network relay hub 500. In the present embodiment, the client 210 is connected to the user terminal apparatus 35 using a network path different from the path connected to the network relay hub 500. The client 210 may be connected to the user terminal apparatus 35 via the network relay hub 500.

The client 210 performs access restriction using ACL and FW. The network load balancer 220 performs access restriction using ACL. The job management manager 230 performs access restriction using ACL and FW.

Here, in the present embodiment, two tenant service providing units 100 and 200 are described, but the number of tenants is not limited thereto. When the number of tenants is larger, the number of subnetworks may be increased. When the number of tenants is smaller and a smaller number of subnetworks is sufficient, the number of subnetworks may be reduced.

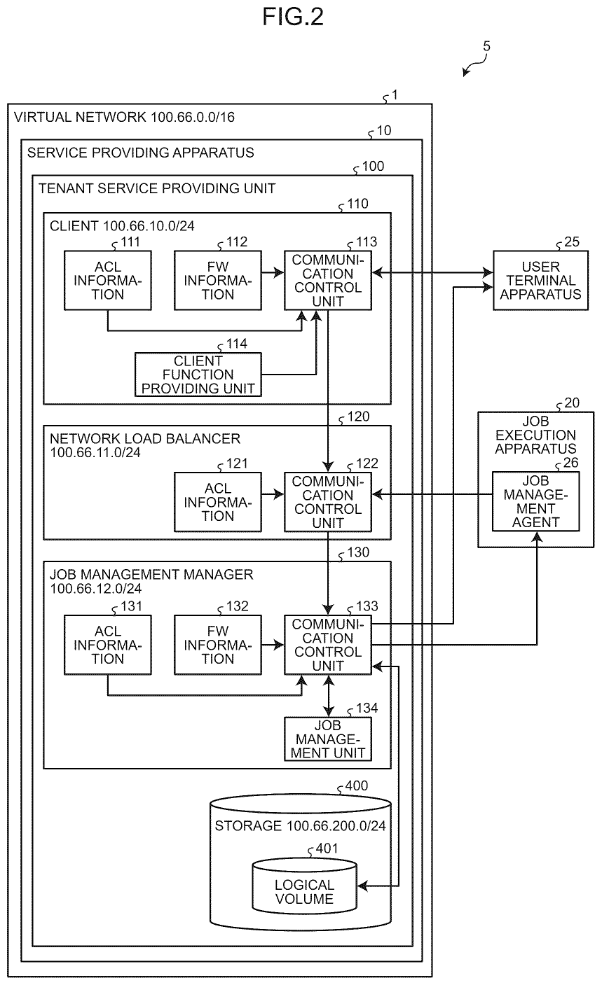

FIG. 2 is a block diagram of the job management service providing system. Since the tenant service providing units 100 and 200 and the like that each provide services to the tenants have the same function, the tenant service providing unit 100 will be described herein as an example. Since the operation of the job management service providing system 5 is the same for any of the on-premises server 21 and the cloud server 23, the apparatuses used by the user P1 for executing the job are collectively referred to as a job execution apparatus 20. A job management agent 26 operates in the job execution apparatus 20.

The user terminal apparatus 25 causes a monitor to display a graphical user interface (GUI) for confirming a manipulation and an operation of the job management manager 130 provided from the client 110 of the tenant service providing unit 100. The user P1 uses the GUI displayed on the monitor to perform the manipulation of the job management manager 130 and to monitor the operation thereof. The user terminal apparatus 25 transmits information of the manipulation input from the user P1 to the job management manager 130 via the client 110. As a result, the user P1 visually confirms a state and a setting situation of a job, and performs request or manipulation of the job on the job management manager 130.

The user terminal apparatus 25 causes the monitor to display a GUI for registering, changing, and monitoring various types of information on the job management manager 130 and the job management agent 26 provided from the client 110. The user P1 registers, changes, and monitors various types of information on the job management manager 130 and the job management agent 26 with reference to the GUI displayed on the monitor. The user terminal apparatus 25 transmits information on registration and changes of various types of information input from the user P1 to the job management manager 130. As a result, the user P1 registers or changes settings of the job management manager 130 or the job management agent 26.

Next, the client 110, the network load balancer 120, and the job management manager 130 provided in the tenant service providing unit 100 will be described. Here, the client 110, the network load balancer 120, and the job management manager 130 each have different subnetworks. Therefore, communication between the client 110, the network load balancer 120, and the job management manager 130 is performed by routing.

The client 110 includes ACL information 111, FW information 112, a communication control unit 113, and a client function providing unit 114. An address of 100.66.10.0/24 is allocated to the client 110.

The client function providing unit 114 generates a GUI for confirming the manipulation and the operation of the job management manager 130, transmits the GUI to the user terminal apparatus 25 via the communication control unit 113, and displays the GUI on the monitor. The client 110 generates a GUI for registering, changing, and monitoring various types of information on the job management manager 130 and the job management agent 26, transmits the GUI to the user terminal apparatus 25 via the communication control unit 113, and displays the GUI on the monitor.

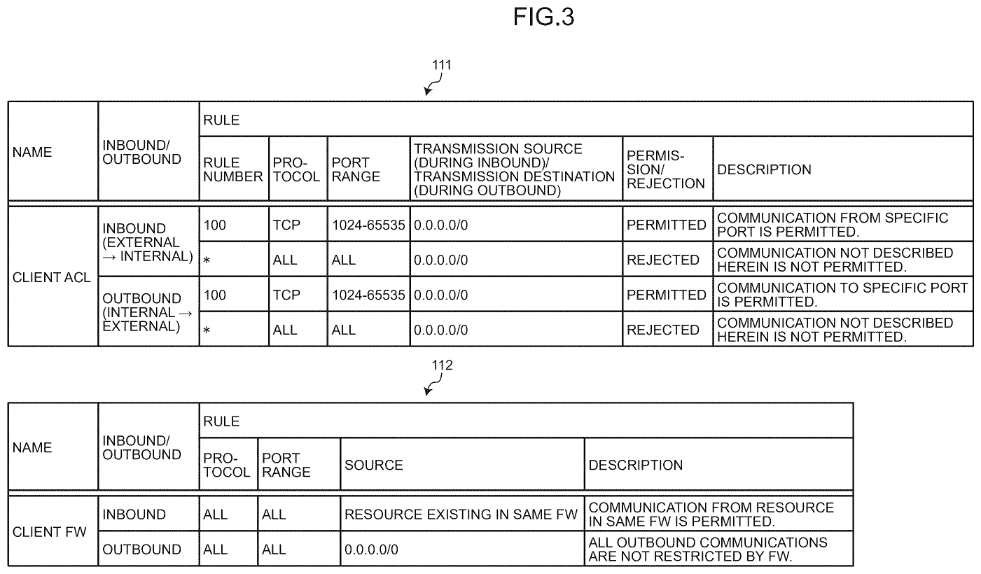

The ACL information 111 is setting information of access control of the client 110 by a client ACL. FIG. 3 is a diagram illustrating setting information of the client ACL and a client FW. For example, as illustrated in FIG. 3, an inbound rule and an outbound rule are registered in the ACL information 111. A target protocol, a port range, a connection destination, and information on permission or rejection are registered in the rules. For example, the ACL information 111 of FIG. 3 is set such that, in communication to the client 110, communication to a port 1024-65535 using TCP (Transmission Control Protocol) is permitted and other communications are not permitted. The ACL information 111 of FIG. 3 is set such that, in communication from the client 110, communication from the port 1024-65535 using TCP is permitted and other communications are not permitted.

The FW information 112 is setting information of access control of the client 110 by the client FW. For example, as illustrated in FIG. 3, an inbound rule and an outbound rule are registered in the FW information 112. A target protocol, a port range, and a source are registered in the rules. For example, the FW information 112 of FIG. 3 is set such that, in the communication to the client 110, communication is permitted for all protocols and all ports that are resources existing in the same FW, and communication from resources existing in other FWs is not permitted. The FW information 112 of FIG. 3 is set such that, in the communication from the client 110, any communication is capable of all protocols and all ports.

The communication control unit 113 receives an instruction to transmit a screen to the user terminal apparatus 25 from the client function providing unit 114. Here, in the instruction from the client function providing unit 114, communication is performed using TCP, and a port permitted to be used is specified in the ACL information 111. The communication control unit 113 refers to the ACL information 111 and confirms that data transmission to the user terminal apparatus 25 is permitted by ACL. The communication control unit 113 refers to the FW information 112 and confirms that data transmission to the user terminal apparatus 25 is permitted by FW. Then, the communication control unit 113 transmits the screen acquired from the client function providing unit 114 to the user terminal apparatus 25.

The communication control unit 113 receives transmission of setting information and manipulation information from the user terminal apparatus 25. Then, the communication control unit 113 refers to the ACL information 111 and the FW information 112, confirms that communication from the user terminal apparatus 25 is permitted, and receives the setting information and the manipulation information from the user terminal apparatus 25.

Next, the communication control unit 113 refers to the ACL information 111 and the FW information 112 and confirms restriction on an output destination. In the present embodiment, the communication control unit 113 is capable of data transmission as long as communication is performed using the port 1024-65535. Therefore, the communication control unit 113 transmits the setting information and the manipulation information received from the user terminal apparatus 25 to the network load balancer 120.

The network load balancer 120 includes ACL information 121 and a communication control unit 122. An address of 100.66.11.0/24 is allocated to the network load balancer 120. The network load balancer 120 bridges access from the client 110 and the job management agent 26 operating in the job execution apparatus 20 to the job management manager 130.

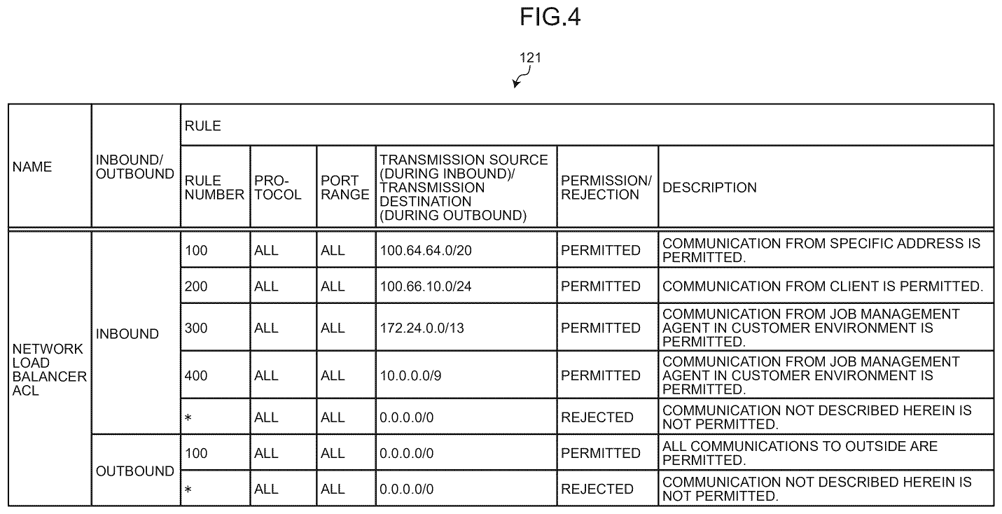

The ACL information 121 is setting information of access control of the network load balancer 120 by a network load balancer ACL. FIG. 4 is a diagram illustrating setting information of the network load balancer ACL. For example, as illustrated in FIG. 4, an inbound rule and an outbound rule are registered in the ACL information 121. A target protocol, a port range, a connection destination, and information on permission or rejection are registered in the rules. For example, in the ACL information 121 of FIG. 4, in communication to the network load balancer 120, communication from a transmission source of any address of 100.64.64.0/20, 100.66.10.0/24, 172.24.0.0/13, and 10.0.0.0/9 is permitted for all protocols and all ports. The ACL information 121 of FIG. 3 is set such that, in communication from the network load balancer 120, any communication is capable of all protocols and all ports.

Here, since 100.66.10.0/24 is the address of the client 110, the ACL information 121 permits communication from the client 110 to the network load balancer 120. Since 172.24.0.0/13 is the address of the on-premises server 21 in FIG. 1, the ACL information 121 permits communication from the on-premises server 21 to the network load balancer 120. Since 10.0.0.0/9 is the address of the cloud server 23 in FIG. 1, the ACL information 121 permits communication from the cloud server 23 to the network load balancer 120. That is, the ACL information 121 permits communication from the job execution apparatus 20 to the network load balancer 120.

Information transmitted from the user terminal apparatus 25 is transmitted to the communication control unit 122 from the communication control unit 113 of the client 110. The communication control unit 122 refers to the ACL information 121 and confirms that communication from the client 110 is permitted. Then, the communication control unit 122 receives the information transmitted from the user terminal apparatus 25.

Job information is transmitted from the job management agent 26 of the job execution apparatus 20 to the communication control unit 122. The communication control unit 122 refers to the ACL information 121 and confirms that communication from the job execution apparatus 20 is permitted. Then, the communication control unit 122 receives the job information transmitted from the job management agent 26.

Then, the communication control unit 122 transmits the received information to the job management manager 130. Here, the job management manager 130 is provided with functions by a plurality of virtual servers from the viewpoint of load distribution and availability. Accordingly, the communication control unit 122 distributes processing to one of the job management managers 130 operating on each available server such that the processing is performed. Then, the communication control unit 122 refers to the ACL information 121 and confirms restriction on an output destination. In the present embodiment, since any communication is capable for all protocols and all ports, the communication control unit 122 can transmit data to the job management manager 130. Therefore, the communication control unit 113 transmits the information transmitted from the user terminal apparatus 25 and the job information transmitted from the job management agent 26 to the job management manager 130.

The job management manager 130 includes ACL information 131, FW information 132, a communication control unit 133, and a job management unit 134. An address of 100.66.12.0/24 is allocated to the job management manager 130.

The job management unit 134 defines, executes, and monitors a job, and schedules and controls the job. The job is, for example, a collection of one or more programs to be continuously executed for a specific purpose such as summing up all of numbers in a table and a collection of instructions to a computer. More specifically, the job management unit 134 performs the following processing. The job management unit 134 has a calendar function of managing an execution date and time of a job, a job scheduling function, a job execution control function, a user management function, and an audit information collection function.

For example, the job management unit 134 performs scheduling of a regular batch work and request and monitoring of a scheduled job as the scheduling function. The regular batch is processing of data collected in a certain period collectively. For example, work of organizing sales in one day corresponds to the regular batch. The job management unit 134 requests and monitors a job of an irregular batch work.

The job management unit 134 controls a job request to the job management agent 26 as the job execution control function. Specifically, the job management unit 134 requests the job management agent 26 to execute a job, and manages the requested job. Manipulation input by the user P1 to the client 110 is processed by the job management unit 134 upon receiving a request. Then, the job management unit 134 transmits a processing result to the user terminal apparatus 25 via the client 110 such that the user P1 confirms a manipulation result. Here, in the above processing, the job management unit 134 stores data in the storage 400 and reads data stored in the storage 400. The job management unit 134 performs communication in the above processing via the communication control unit 133.

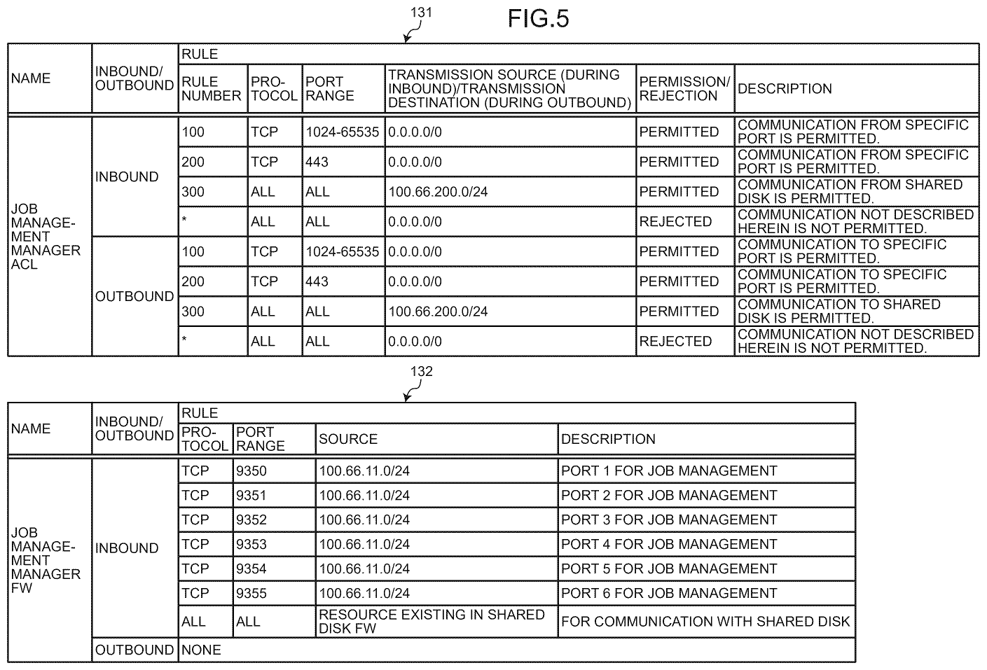

The ACL information 131 is setting information of access control of the job management manager 130 by a job management manager ACL. FIG. 5 is a diagram illustrating setting information of the job management manager ACL and a job management manager FW. For example, as illustrated in FIG. 5, an inbound rule and an outbound rule are registered in the ACL information 131. A target protocol, a port range, a connection destination, and information on communication permission or rejection are registered in the rules.

For example, the ACL information 131 of FIG. 5 is set such that, in communication to the job management manager 130, communication to ports 1024-65535 and 443 that use TCP is permitted. The ACL information 131 is set such that, in the communication to the job management manager 130, communication from a transmission source having an address of 100.66.200.0/24 is permitted for all protocols and all ports. Accordingly, communication from the storage 400 as a shared disk is permitted. The ACL information 131 is set such that communication other than the above-described communication of the communication to the job management manager 130 is not permitted.

The ACL information 131 of FIG. 3 is set such that, in communication from the job management manager 130, communication from the ports 1024-65535 and 443 that use TCP is permitted. The ACL information 131 is set such that, in the communication from the job management manager 130, communication to a transmission destination having an address of 100.66.200.0/24 is permitted. As a result, communication to the storage 400 as a shared disk is permitted. The ACL information 131 is set such that communication other than the above-described communication in the communication from the job management manager 130 is not permitted.

The FW information 132 is information for setting access control of the job management manager 130 by the job management manager FW. For example, as illustrated in FIG. 5, an inbound rule and an outbound rule are registered in the FW information 132. A target protocol, a port range, and a source are registered in the rules. For example, in the FW information 132 of FIG. 5, in communication to the job management manager 130, communication is permitted to a port 9350-9355 that uses TCP when an address of a transmission source is 100.66.11.0/24. The FW information 132 is set such that any communication is capable for all protocols and all ports as long as a resource exists in a shared disk FW.

The FW information 132 is set such that, in communication to the job management manager 130 communication is capable when the source address exists in a resource within the FW for a storage 400. Accordingly, communication with the storage 400 as a shared disk is permitted. The FW information 132 is set such that communication is capable for outbound without restriction of a communication counterpart.

Information transmitted from the user terminal apparatus 25 or job information transmitted from the job management agent 26 is transmitted from the network load balancer 120 to the communication control unit 133. Communication from the network load balancer 120 is performed to the port 1024-65535 that uses TCP when the communication is transmission of information other than information for job management. When information is for job management, communication is performed to the port 9350-9355 that uses TCP. The communication control unit 133 first refers to the ACL information 131 and confirms that communication to the port 1024-65535 that uses TCP is permitted. Subsequently, the communication control unit 133 refers to the FW information 132 and confirms that communication from the network load balancer 120 is permitted when the communication is to the port 9350-9355 that uses TCP. Then, the communication control unit 133 receives the information transmitted from the user terminal apparatus 25 or the job information transmitted from the job management agent 26.

The communication control unit 133 receives an instruction to access the storage 400 from the job management unit 134. Then, the communication control unit 133 refers to the ACL information 131 and the FW information 132 and confirms that communication to the storage 400 is permitted. Then, the communication control unit 133 accesses the storage 400 to read and write data.

The communication control unit 133 outputs setting information, control information, and the like acquired from the job management unit 134 or the user terminal apparatus 25 to the job management agent 26 of the job execution apparatus 20 using a rule permitted by the ACL information 131.

Here, for example, data transmission from the communication control unit 113 of the client 110 to the communication control unit 133 will be considered. Here, the communication control unit 133 refers to the ACL information 131 and the FW information 132 and confirms that data reception from the client 110 is not permitted. Then, the communication control unit 133 does not receive the data transmitted from the communication control unit 113 of the client 110. As such, unexpected access is restricted even in the same tenant service providing unit 100. For example, access to a port that is not desired to be permitted is not performed.

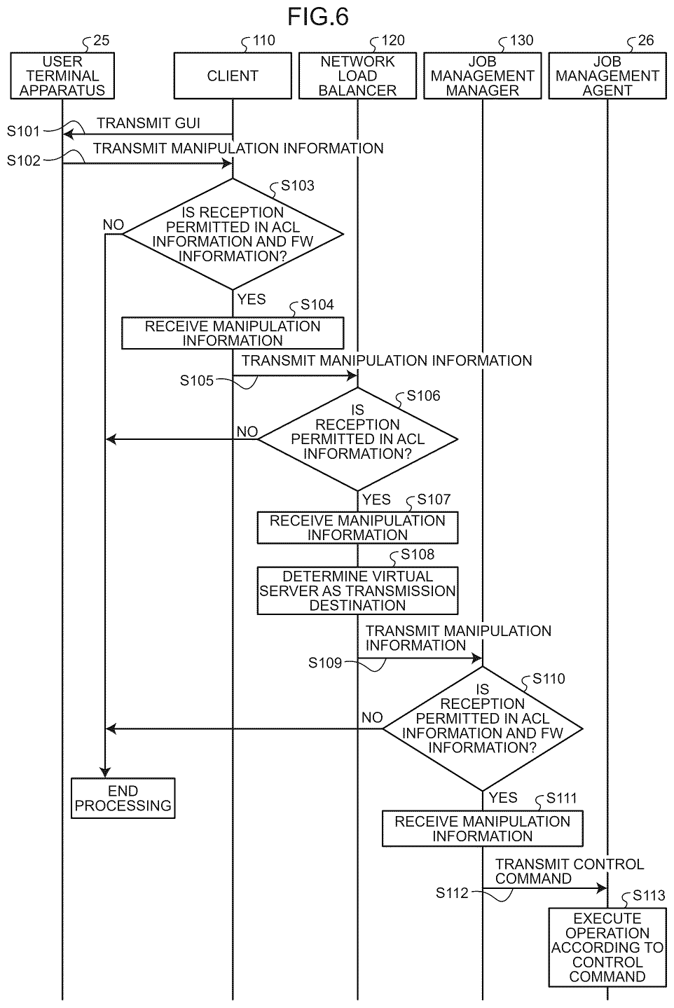

FIG. 6 is a sequence diagram of processing of manipulation of a job management manager by a user. Next, a flow of the processing of the manipulation of the job management manager 130 by the user P1 will be described with reference to FIG. 6.

The client function providing unit 114 of the client 110 generates a GUI for manipulating the job management manager 130. The communication control unit 113 refers to the ACL information 111 and the FW information 112 and confirms that data transmission to the user terminal apparatus 25 is permitted. Then, the communication control unit 113 transmits the GUI generated by the client function providing unit 114 to the user terminal apparatus 25 and displays the GUI on the monitor (step S101).

The user P1 inputs the manipulation of the job management manager 130 using the GUI displayed on the monitor of the user terminal apparatus 25. Upon receiving the manipulation input from the user P1, the user terminal apparatus 25 transmits manipulation information to the client 110 (step S102).

The communication control unit 113 of the client 110 refers to the ACL information 111 and the FW information 112 and determines whether data reception from the user terminal apparatus 25 is permitted (step S103). When data reception is not permitted (step S103: No), the client 110 ends the processing of the manipulation of the job management manager 130.

Meanwhile, when data reception is permitted (step S103: Yes), the communication control unit 113 receives the manipulation information (step S104).

Next, the communication control unit 113 refers to the ACL information 111 and the FW information 112 and confirms that data transmission to the network load balancer 120 is permitted. Then, the communication control unit 113 transmits the manipulation information to the network load balancer 120 (step S105).

The communication control unit 122 of the network load balancer 120 refers to the ACL information 121 and determines whether data reception from the client 110 is permitted (step S106). When data reception is not permitted (step S106: No), the network load balancer 120 ends the processing of the manipulation of the job management manager 130.

Meanwhile, when data reception is permitted (step S106: Yes), the communication control unit 122 of the network load balancer 120 receives the manipulation information (step S107).

Next, the communication control unit 122 determines a virtual server as a transmission destination among the plurality of virtual servers on which the job management manager 130 operates (step S108).

Next, the communication control unit 122 refers to the ACL information 121 and confirms that data transmission to the job management manager 130 is permitted. Then, the communication control unit 122 transmits the manipulation information to the job management manager 130 operating on the selected virtual server (step S109).

The communication control unit 133 of the job management manager 130 refers to the ACL information 131 and the FW information 132 and determines whether data reception from the network load balancer 120 is permitted (step S110). When data reception is not permitted (step S110: No), the job management manager 130 ends the processing of the manipulation of the job management manager 130.

Meanwhile, when data reception is permitted (step S110: Yes), the communication control unit 133 receives the manipulation information (step S111).

Next, the job management unit 134 of the job management manager 130 operates according to the manipulation information. Here, a description will be given as to a case in which the job management manager 130 receives manipulation of causing the job management agent 26 to perform a predetermined operation. The job management unit 134 generates a control command that causes the job management agent 26 to perform a predetermined operation according to the manipulation information. The communication control unit 133 refers to the ACL information 131 and the FW information 132 and confirms that data transmission to the job execution apparatus 20 is permitted. Then, the communication control unit 133 transmits the control command acquired from the job management unit 134 to the job management agent 26 of the job execution apparatus 20 (step S112).

The job management agent 26 of the job execution apparatus 20 receives the control command and executes a predetermined operation according to the control command (step S113).

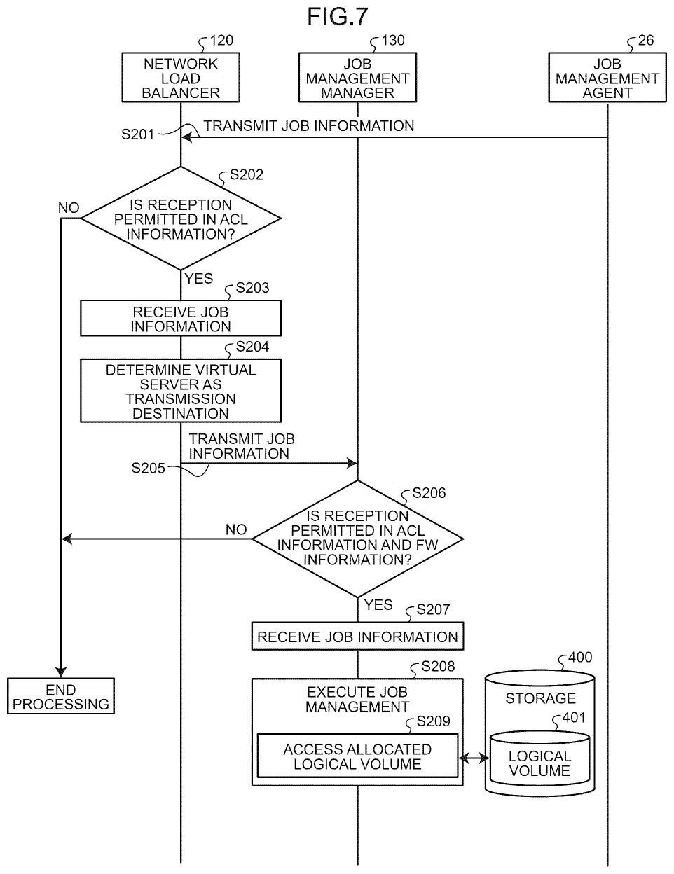

FIG. 7 is a sequence diagram of job management processing based on job information. Next, a flow of the job management processing based on the job information will be described with reference to FIG. 7.

The job management agent 26 of the job execution apparatus 20 transmits job information to the network load balancer 120 (step S201).

The communication control unit 122 of the network load balancer 120 refers to the ACL information 121 and determines whether data reception from the job execution apparatus 20 is permitted (step S202). When data reception is not permitted (step S202: No), the network load balancer 120 ends the job management processing.

Meanwhile, when data reception is permitted (step S202: Yes), the communication control unit 122 of the network load balancer 120 receives the job information (step S203).

Next, the communication control unit 122 determines a virtual server as a transmission destination among the plurality of virtual servers on which the job management manager 130 operates (step S204).

Next, the communication control unit 122 refers to the ACL information 121 and confirms that data transmission to the job management manager 130 is permitted. Then, the communication control unit 122 transmits the job information to the job management manager 130 operating on the selected virtual server (step S205).

The communication control unit 133 of the job management manager 130 refers to the ACL information 131 and the FW information 132 and determines whether data reception from the network load balancer 120 is permitted (step S206). When data reception is not permitted (step S206: No), the job management manager 130 ends the job management processing.

Meanwhile, when data reception is permitted (step S206: Yes), the communication control unit 133 receives the job information (step S207).

Then, the job management unit 134 of the job management manager 130 executes job management using the acquired job information (step S208). Then, for example, the job management unit 134 instructs the communication control unit 133 to access the storage 400 during the job management. The communication control unit 133 refers to the ACL information 131 and the FW information 132 and confirms that access to the storage 400 is permitted. Then, the communication control unit 133 accesses the allocated logical volume 401 in the storage 400 (step S209). Thereafter, the job management unit 134 completes the execution of the job management.

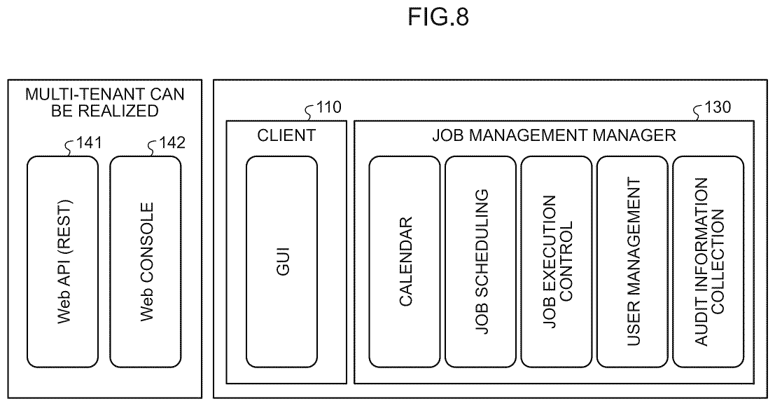

The job management service providing system 5 includes a path in which the user terminal apparatus 25 accesses the job management manager 130 via the Web without passing the client 110. FIG. 8 is a diagram illustrating a list of job management functions. As described above, the client 110 provides a GUI to the user P1. The job management manager 130 has a calendar function, a job scheduling function, a job execution control function, a user management function, and an audit information collection function. Apart from the above functions, functions of the job management service provided by the job management service providing system 5 include a Web API 141 and a Web console 142 for manipulating the job management manager 130 from the Web. Using the Web API 141 and the Web console 142, the user P1 can manipulate the job management manager 130 via the network load balancer 120 from the Web without passing the client 110.

The Web API 141 according to the present embodiment is implemented according to REST (Representational State Transfer). The client 110 and the job management manager 130 are provided for each tenant, and it is difficult to realize multi-tenancy in which common usage for a plurality of tenants is implemented. Meanwhile, the Web API 141 and the Web console 142 can realize multi-tenancy. Therefore, in the job management service providing system 5 according to the present embodiment, portions of the Web API 141 and the Web console 142 are provided in a dedicated commonly used portion 42 and shared commonly.

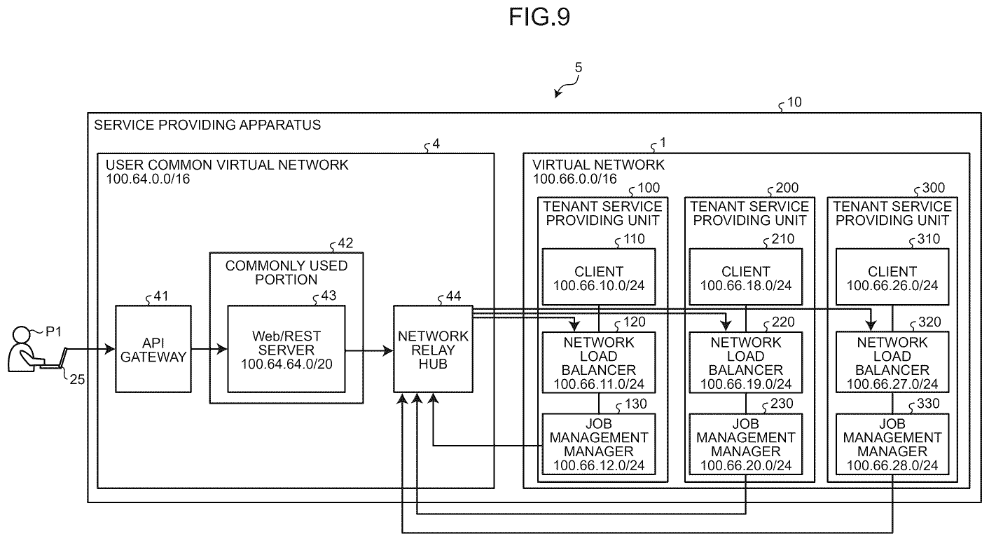

FIG. 9 is a diagram illustrating a configuration in which a Web/REST server is made common. As illustrated in FIG. 9, the job management service providing system 5 includes the virtual network 1 and a user common virtual network 4. The service providing apparatus 10 includes the tenant service providing units 100, 200, and 300 provided in the virtual network 1, and further includes an API Gateway 41, the commonly used portion 42, and a network relay hub 44 provided in the user common virtual network 4.

The virtual network 1 includes the tenant service providing units 100, 200, and 300. Here, in the present embodiment, a description will be given as to a case in which the user P1 uses three tenants provided by the tenant service providing units 100, 200, and 300.

For example, a subnetwork having an address of 100.64.0.0/16 among the shared addresses conforming to RFC6598 is allocated to the user common virtual network 4. The user P1 can access the job management managers 130, 230, and 330 via each of the clients 110, 210, and 310, and can also access the job management managers 130, 230, and 330 via the user common virtual network 4. The user common virtual network 4 can also be used when another user accesses a tenant for the user. That is, the user common virtual network 4 is shared by a plurality of users including the user P1.

The user common virtual network 4 includes the API Gateway 41, the commonly used portion 42, and the network relay hub 44. The API Gateway 41 is a gateway for the user terminal apparatus 25 to access the commonly used portion 42.

The commonly used portion 42 includes a Web/REST server 43. The Web/REST server 43 has functions of the Web API 141 and the Web console 142. For example, a subnetwork having an address of 100.64.64.0/20 among the shared addresses conforming to RFC6598 is allocated to the Web/REST server 43. The Web/REST server 43 is connected to the network load balancers 120, 220, and 320 and the job management managers 130, 230, and 330 disposed in the virtual network 1 via the network relay hub 44. The Web/REST server 43 corresponds to an example of a “shared function” and a “common unit”.

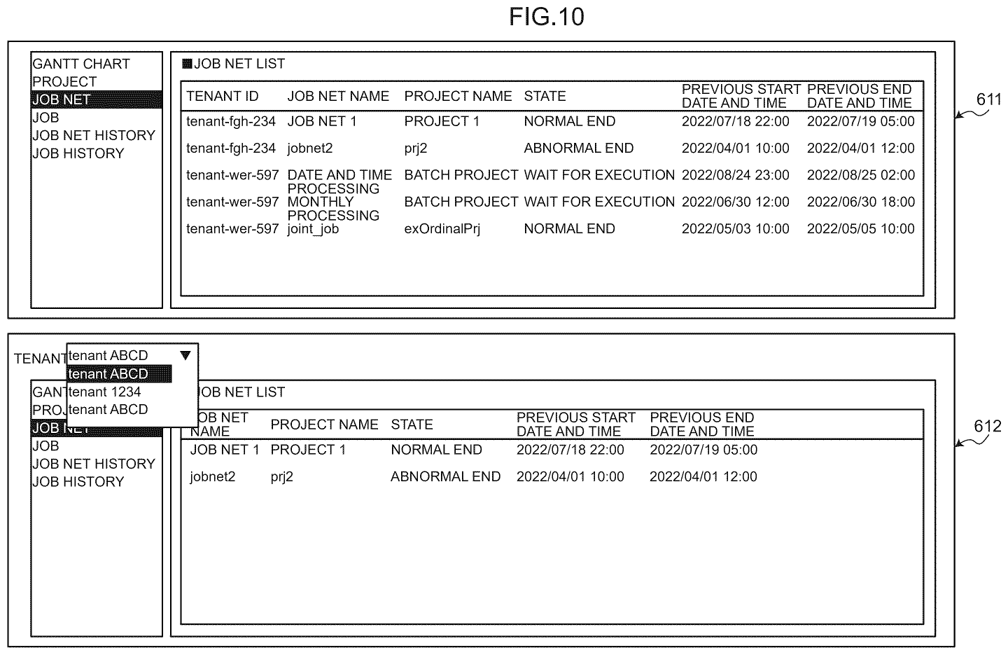

FIG. 10 is an image diagram of an example of a job information display screen. For example, the Web/REST server 43 transmits a job information display screen 611 or 612 illustrated in FIG. 10 to the user terminal apparatus 25 and causes the monitor to display the screen. The user P1 can control job management using the job information display screen 611 or 612.

For example, on the job information display screen 611, when a job net is selected from selection items in a left column of the drawing, a list of job nets including jobs to be managed in a tenant that can be used by the user P1 is displayed.

On the job information display screen 612, when a job net is selected, a drop-down list of names of tenants available to the user P1 is displayed. Then, on the job information display screen 612, when a specific tenant (a “tenant ABCD” in the example of FIG. 10) is selected from the list of the names of the tenants in the drop-down list, a list of the job nets in the selected specific tenant is displayed.

The user terminal apparatus 25 can access the network load balancers 120, 220, and 320 disposed in the virtual network 1 via the Web using the Web/REST server 43 via the API Gateway 41.

For example, the ACL information 121 of the network load balancer 120 permits communication from the address of 100.64.64.0/20 as illustrated in FIG. 4. The Web/REST server 43 has an address of 100.64.64.0/20 and can access the network load balancer 120.

The user terminal apparatus 25 can access the job management managers 130, 230, and 330 provided in the virtual network 1 via the Web using the Web/REST server 43 via the API Gateway 41.

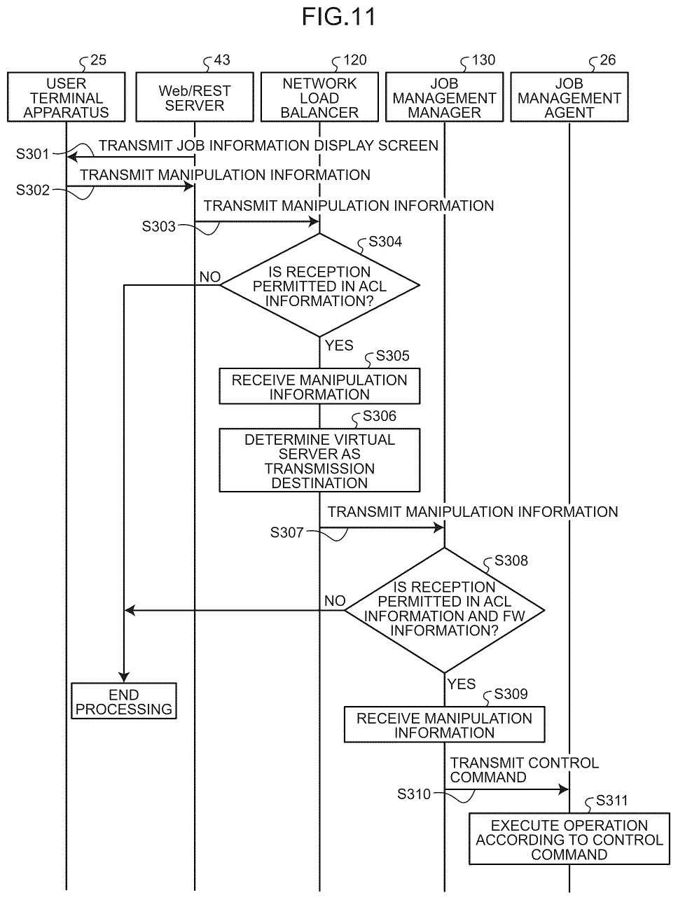

FIG. 11 is a sequence diagram of processing of manipulation of a job management manager using the Web/REST server. Next, a flow of the processing of the manipulation of the job management manager 130 using the Web/REST server 43 will be described with reference to FIG. 11.

The Web/REST server 43 transmits a job information display screen to the user terminal apparatus 25 and causes a monitor to display the screen (step S301).

The user P1 monitors a job using the job information display screen displayed on the monitor of the user terminal apparatus 25 and inputs manipulation of the job management manager 130. In response to the manipulation input from the user P1, the user terminal apparatus 25 transmits manipulation information to the Web/REST server 43 (step S302).

The Web/REST server 43 transmits the manipulation information transmitted from the user terminal apparatus 25 to the network load balancer 120 (step S303).

The communication control unit 122 of the network load balancer 120 refers to the ACL information 121 and determines whether data reception from the Web/REST server 43 is permitted (step S304). When data reception is not permitted (step S304: No), the network load balancer 120 ends the processing of the manipulation of the job management manager 130.

Meanwhile, when data reception is permitted (step S304: Yes), the communication control unit 122 of the network load balancer 120 receives the manipulation information (step S305).

Next, the communication control unit 122 determines a virtual server as a transmission destination among the plurality of virtual servers on which the job management manager 130 operates (step S306).

Next, the communication control unit 122 refers to the ACL information 121 and confirms that data transmission to the job management manager 130 is permitted. Then, the communication control unit 122 transmits the manipulation information to the job management manager 130 operating on the selected virtual server (step S307).

The communication control unit 133 of the job management manager 130 refers to the ACL information 131 and the FW information 132 and determines whether data reception from the network load balancer 120 is permitted (step S308). When data reception is not permitted (step S308: No), the job management manager 130 ends the processing of the manipulation of the job management manager 130.

Meanwhile, when data reception is permitted (step S308: Yes), the communication control unit 133 receives the manipulation information (step S309).

Next, the job management unit 134 of the job management manager 130 operates according to the manipulation information. Here, a description will be given as to a case in which the job management manager 130 receives manipulation of causing the job management agent 26 to perform a predetermined operation. The job management unit 134 generates a control command that causes the job management agent 26 to perform a predetermined operation according to the manipulation information. The communication control unit 133 refers to the ACL information 131 and the FW information 132 and confirms that data transmission to the job execution apparatus 20 is permitted. Then, the communication control unit 133 transmits the control command acquired from the job management unit 134 to the job management agent 26 of the job execution apparatus 20 (step S310).

The job management agent 26 of the job execution apparatus 20 receives the control command and executes a predetermined operation according to the control command (step S311).

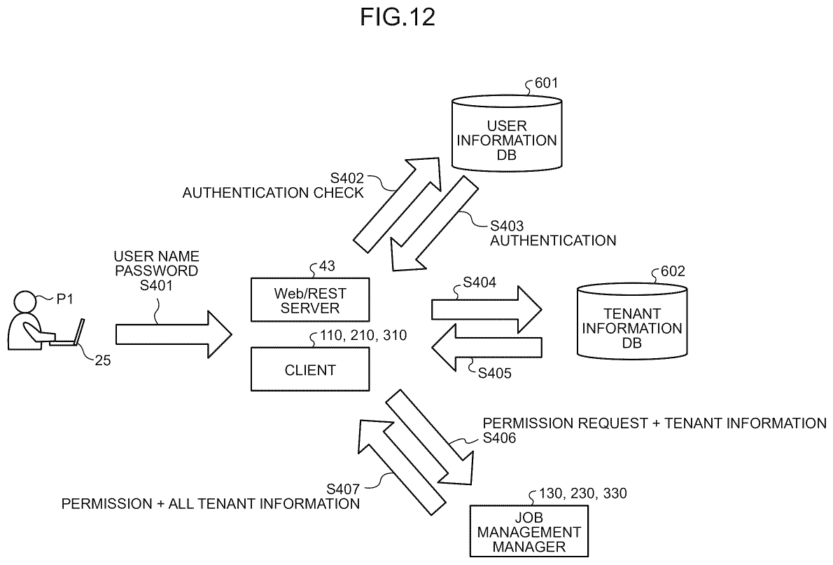

The job management service providing system 5 according to the present embodiment manages access by the user P1 to a plurality of tenants using a database (DB) including user information and a DB including tenant information in combination. FIG. 12 is an image diagram of connection of the job management service providing system. The job management service providing system 5 according to the present embodiment includes a user information DB 601 and a tenant information DB 602.

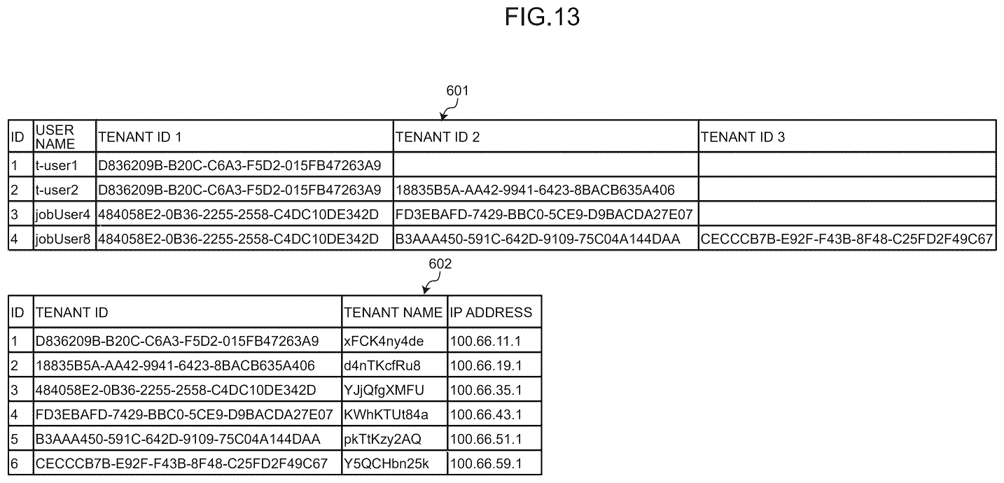

The user information DB 601 manages information of a plurality of users including the user P1. FIG. 13 is a diagram of an example of the user information DB and the tenant information DB. For example, as illustrated in FIG. 13, in the user information DB 601, information of each tenant used by a user is registered in association with a user name that is identification information of the user. A tenant ID 1 is identification information of a first tenant used by each user. A tenant ID 2 is identification information of a second tenant used by each user. A tenant ID 3 is identification information of a third tenant used by each user. For example, when the user P1 has two tenants, the identification information of each tenant is stored in the tenant ID 1 and the tenant ID 2 of the user information DB 601. A password of each user is also stored in the user information DB 601.

The tenant information DB 602 manages information on a plurality of tenants connectable via the network relay hub 44. For example, as illustrated in FIG. 13, a tenant name and an IP address are registered in the tenant information DB 602 in association with the tenant ID.

Referring back to FIG. 12, a procedure of access to the job management manager 130 by the user P1 will be described. The user P1 can access the job management managers 130, 230, and 330 using any of the Web/REST server 43 or the clients 110, 210, and 310, but here, a case of access using the Web/REST server 43 will be described.

The user P1 transmits a user name and a password to the Web/REST server 43 using the user terminal apparatus 25 (step S401).

The Web/REST server 43 requests the user information DB 601 using the user name and the password to authenticate the user P1 and check a tenant to be used by the user P1 (step S402).

The user information DB 601 performs authentication using the user name and the password of the user P1, and when the authentication is successful, the user information DB 601 responds to the Web/REST server 43 with a tenant ID of the tenant used by the user P1 (step S403).

Next, the Web/REST server 43 transmits an acquisition request to the tenant information DB 602 to acquire tenant information of each of the tenant service providing units 100, 200, and 300 used by the user P1 using the tenant ID (step S404).

The tenant information DB 602 responds to the Web/REST server 43 with the tenant information such as a tenant name and an IP address corresponding to the transmitted tenant ID (step S405).

Next, the Web/REST server 43 transmits a permission request of connection using the tenant information to the job management managers 130, 230, and 330 each operating in the tenant service providing units 100, 200, and 300 used by the user P1. Here, in practice, data transmission from the Web/REST server 43 to each of the job management managers 130, 230, and 330 passes the network load balancers 120, 220, and 320 (step S406).

The job management managers 130, 230, and 330 authorize access by confirming restriction by ACL and FW, and respond to the Web/REST server 43 with all pieces of tenant information of the tenant service providing units 100, 200, and 300 (step S407). As a result, the user terminal apparatus 25 can use the job management managers 130, 230, and 330.

As described above, in the service providing system according to the present embodiment, in a resource that provides a service in the multi-tenant environment, a subnetwork is divided at a finer granularity than a tenant unit, for each function in each tenant, and ACL and FW are assigned to each function. As a result, it is possible to minimize an area open to the outside, and it is possible to strengthen access restriction to the job management manager.

The job management service providing system according to the present embodiment causes the Web console and the Web API server to be commonly used among a plurality of users. As a result, it is possible to not provide the Web console and the Web API server for each tenant, and used resources can be reduced. A user who uses a plurality of tenants can use each tenant via a common Web console and Web API server without accessing a client for each tenant, and convenience is improved.

The job management service providing system according to the present embodiment uses both the user information DB and the tenant information DB to acquire accessible tenant information associated with the user, and causes the user to manage a plurality of tenants in a list using the job information display screen. Accordingly, the user can simultaneously browse and operate a plurality of tenants. When each of the tenants is managed separately, for example, management for each tenant contract is performed for payout assets, and management of the tenant becomes complicated for a user who contracted a plurality of tenants by one person. Meanwhile, the job management service providing system according to the present embodiment can consolidate the scattered job management managers into one virtual manager capable of collective manipulation. As a result, even when a user has contracted a plurality of tenants, the user can obtain convenience of manipulation equivalent to that of a single-tenant contract. Therefore, it is possible to reduce a management burden regarding service use and improve user convenience.

By employing the multi-tenant configuration in job management service provision, the number of used infrastructures is reduced as compared with the single-tenant environment, and costs generated by using the cloud infrastructure can be reduced.

A shared address conforming to RFC6598 is used in a resource for performing job management for each tenant. The shared address is not allocated to a user terminal apparatus or a job execution apparatus, and network collision hardly occurs between the resource and the user terminal apparatus or the job execution apparatus. Therefore, for example, even when the number of tenants is increased, the number of virtual networks does not need to be increased for avoiding network collision, and the number of provided virtual networks can be reduced. Accordingly, it is possible to reduce costs related to use of the cloud infrastructure.

In the service providing system according to the present embodiment, a logical volume is allocated to each user and a storage common for users is used. As described above, a fixed cost for using the cloud infrastructure can be reduced by making a high-speed and high-cost storage used in the job management to be commonly used by the users. Security can be ensured by restricting access by the users to the storage. Therefore, it is possible to provide a job management service that ensures convenience of the service while ensuring security.

### Hardware Configuration

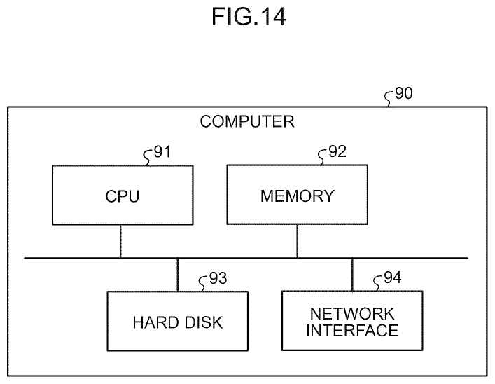

FIG. 14 is a hardware configuration diagram of a computer. Next, an example of a hardware configuration for implementing each function of the service providing apparatus 10 will be described with reference to FIG. 14.

The service providing apparatus 10 can be implemented by, for example, a computer 90 illustrated in FIG. 14. The computer 90 includes, for example, a central processing unit (CPU) 91, a memory 92, a hard disk 93, and a network interface 94. The CPU 91 is connected to the memory 92, the hard disk 93, and the network interface 94 via a bus.

The network interface 94 is an interface for communication between the computer 90 and an external device. The network interface 94 relays, for example, communication between the CPU 91 and the user terminal apparatus 25 and the job execution apparatus 20.

The hard disk 93 is an auxiliary storage device. The hard disk 93 implements the functions of the storage 400 illustrated in FIG. 2. The hard disk 93 implements the functions of the tenant service providing units 100 and 200 illustrated in FIG. 1. More specifically, for example, for the tenant service providing unit 100, the hard disk 93 stores a program for implementing the functions of the client 110, the network load balancer 120, and the job management manager 130 illustrated in FIG. 2. The hard disk 93 may store the ACL information 111, the FW information 112, the ACL information 121, the ACL information 131, and the FW information 132 illustrated in FIG. 2.

The memory 92 is a main storage device. For example, a dynamic random access memory (DRAM) can be used as the memory 92.

The CPU 91 reads various programs from the hard disk 93 and loads and executes the programs in the memory 92. As a result, the CPU 91 implements the functions of the tenant service providing units 100 and 200 illustrated in FIG. 1. More specifically, for example, for the tenant service providing unit 100, the CPU 91 implements the functions of the client 110, the network load balancer 120, and the job management manager 130 illustrated in FIG. 2.

Although a case in which the service providing apparatus 10 is implemented by one computer 90 is described here, the service providing apparatus 10 may be implemented by a plurality of computers 90.

In one aspect, the present invention can ensure convenience of a service while ensuring security.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium having stored therein a service providing program that causes a computer to execute a process comprising:
in one resource that provides a job management service using a specific network, the resource having a plurality of tenants set therein, each of the tenants having a plurality of functions for performing job management set therein, each of the functions being allocated with a different subnetwork of the specific network,
performing individual access restriction for each of the functions based on the subnetwork; and
performing individual job management for each of the tenants using a shared function of the plurality of tenants in the job management provided in a commonly used portion of the plurality of tenants of the resource and the functions set for each of the tenants.

2. The non-transitory computer-readable recording medium according to claim 1, wherein the program causes the computer to further execute a process of performing the job management using a function of accessing the tenant via Web disposed in the commonly used portion of the resource as the shared function.

3. The non-transitory computer-readable recording medium according to claim 1, wherein the program causes the computer to further execute a process of
providing a job information display screen that collectively displays a plurality of pieces of information on the job management of the plurality of tenants to a user and performing the job management using information input from the user from the job information display screen.

4. The non-transitory computer-readable recording medium according to claim 1, wherein the program causes the computer to further execute a process of performing the access restriction and the job management using a shared address allocated to the specific network.

5. The non-transitory computer-readable recording medium according to claim 1, wherein the program causes the computer to further execute a process of performing the job management for each of the plurality of tenants using a logical volume allocated to each of the tenants in a storage common to the tenants.

6. A service providing method comprising:
in one resource that provides a job management service using a specific network, the resource having a plurality of tenants set therein, each of the tenants having a plurality of functions for performing job management set therein, each of the functions being allocated with a different subnetwork of the specific network,
performing individual access restriction for each of the functions based on the subnetwork; and
performing individual job management for each of the tenants using a shared function of the plurality of tenants in the job management provided in a commonly used portion of the plurality of tenants of the resource and the functions set for each of the tenants, by a processor.

7. A service providing apparatus having a specific network allocated thereto and a plurality of tenants each of which provides a job management service set therein, the service providing apparatus comprising:
a memory and;
a processor coupled to the memory and configured to:
generate a shared function provided in a commonly used portion of the plurality of tenants, the a shared function being shared by the plurality of tenants in access to each of the tenants in job management;
allocate with a different first subnetwork for each of the tenants in the specific network, perform access control based on the first subnetwork, and transmit and receive information to and from a user terminal apparatus for each of the tenants; and
allocate with a different second subnetwork for each of the tenants in the specific network, perform access control based on the second subnetwork, and perform the job management for a job to be executed by a job execution apparatus and different for each of the tenants using information from the user terminal apparatus and information from the shared function.

8. The service providing apparatus according to claim 7, wherein the processor is further configured to performs the job management using a function of accessing the tenant via a Web disposed in the commonly used portion of the resource as the shared function.

9. The service providing apparatus according to claim 7, wherein the processor is further configured to provides a job information display screen that collectively displays a plurality of pieces of information on the job management of the plurality of tenants to a user and performs the job management using information input from the user from the job information display screen.

10. The service providing apparatus according to claim 7, wherein the processor is further configured to performs the access restriction and the job management using a shared address allocated to the specific network.

11. The service providing apparatus according to claim 7, wherein the processor is further configured to performs the job management for each of the plurality of tenants using a logical volume allocated to each of the tenants in a storage common to the tenants.
